(19) United States
(12) Patent Application Publication
(10) Pub. No.: US 2008/0227445 A1
(43) Pub. Date: Sep. 18, 2008

(54) Paging scheme

(75) Inventors: Haitao Tang, Espoo (FI); Petteri Poyhonen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/716,887

(22) Filed: Mar. 12, 2007

(51) Int. Cl. H04Q 7/20

(52) U.S. Cl. 455/426.1

(57) ABSTRACT

Disclosed is a multi-access device including a communication unit including capabilities for communicating through access networks according to at least two different access technologies. The multi-access device receives a paging message at least through an access network according to one of the at least two different access technologies, selects one of the access networks available for the multi-access device in response to the paging message, and answers to the paging message through the selected access network. Also disclosed is a paging center configured to initiate paging of a given multi-access device, to use an access network according to a first default access technology for the paging, and to wait for to receive an answer to the paging through an access network according to any access technology available in the communication network, said access network, through which an answer is received, having been selected for the multi-access device in response to said paging.

### FIELD OF THE INVENTION

The present invention generally relates to paging in communication networks.

### BACKGROUND OF THE INVENTION

Mobile phones or other communication devices are often equipped with more than one access technology for accessing communication networks. The available access technologies may be wireless access technologies, such as GSM, CDMA, UMTS and WLAN, or fixed line access technologies, such as Ethernet, ADSL and PSTN. These communication devices are below referred to as multi-access devices.

On the other hand, battery lifetime is usually a limited resource in (wireless) communication devices and maintaining many active access technologies may consume significant amount on energy. Thus, even though plurality of access technologies may be available in the multi-access devices, as many as possible of them need to be kept in idle/passive mode in order to save battery life. When there is no ongoing communication between the multi-access devices and their associated access networks, the multi-access devices usually put all their access technologies into idle/passive mode. This effectively saves battery lifetime.

Saving battery lifetime in this way causes a problem of knowing which access technology to use for paging a given multi-access device when initiating a connection towards the multi-access device as the access technologies are in idle mode in the multi-access device. Given the mobile nature of most multi-access devices, the available access networks tend to change from time to time as the multi-access device moves (or is moved) to different places. It is usually not practical to page using all available access technologies.

EP1616446 discloses a method of keeping a terminal reachable through a first access network. The terminal scans and reports availability of other access networks to the first access network. Paging of the terminal is performed in the first access network and, on the basis of the reports that have been provided by the terminal before, the paging message readily comprises information about which is the preferred access network to use for setting up the call. The call is then set up directly in the preferred access network.

In EP1068758 a database comprising contactability information of mobile stations in maintained in network. The contactability information is used for paging mobile stations and updated according to changes detected in status of the mobile stations.

Still another known solution is to have a specific network entity that is aware of physical resources of a multi-access device. The multi-access device continuously reports its RAT (Radio Access Technology) status to the specific network entity so that the network entity is able to contact the multi-access device when needed.

### SUMMARY

Now another alternative paging scheme for use in connection with multi-access devices is provided.

According to a first aspect of the invention there is provided a multi-access device comprising:

a communication unit comprising capabilities for communicating through access networks according to at least two different access technologies, and
a processing unit, wherein
the communication unit is configured to receive a paging message at least through an access network according to one of the at least two different access technologies, and
the processing unit is configured
to select one of the access networks available for the multi-access device in response to the paging message, and
to co-operate with the communication unit to answer to the paging message through the selected access network.

According to a second aspect of the invention there is provided a paging center for use in a communication network, comprising:

a memory,
a processing unit coupled to the memory, the processing unit being configured to initiate paging of a given multi-access device,
to use an access network according to a first default access technology for the paging, and
to wait for to receive an answer to the paging through an access network according to any access technology available in the communication network, said access network, through which an answer is received, having been selected for the multi-access device in response to said paging.

According to a third aspect of the invention there is provided a method in a multi-access device, the method comprising:

receiving a paging message through an access network according to a first access technology,
selecting one of the access networks available for the multi-access device in response to the paging message, and
answering to the paging message through the selected access network.

The method of the third aspect may further comprise evaluating access networks available for the multi-access device before selecting one of the access networks,

In an embodiment of the invention the evaluation and/or selection are performed in co-operation with the associated access networks.

The selected access network may be for example the best access network or a suitable access network.

The method of the third aspect may further comprise

establishing a connection between the multi-access device and a paging center through the selected access network, and
sending said answer to the paging message through said established connection.

In an embodiment of the invention the established connection between the multi-access device and the paging center is used for communicating with a calling party, which has originally requested paging of the multi-access device.

Further the method of the third aspect may comprise performing a registration procedure with a paging center to register at least one preferred access technology to be used for paging said multi-access device.

According to a fourth aspect of the invention there is provided a method in a communication network, the method comprising:

initiating paging of a given multi-access device,
using an access network according to a first default access technology for said paging, and
waiting for to receive an answer to the paging through an access network according to any access technology available in the communication network, said access network, through which an answer is received, having been selected for the multi-access device in response to said paging.

The method of the fourth aspect may further comprise

waiting for to receive an answer to the paging for a predetermined time, and
if an answer is not received during the predetermined time, using an access network according to another default access technology for the paging.

In an embodiment of the invention one iterates the paging by using access networks according to further default access technologies until an answer is received through some access network or the default access technologies are exhausted.

In another embodiment of the invention one uses in parallel two or more access networks according to one or more default access technologies for the paging.

Further the method of the fourth aspect may comprise

initiating said paging in response to a paging request from an application, and
informing said application of the access network through which the answer to the paging is received.

The application may be for example a calling application trying to reach said multi-access device, a network function, or a part of a paging functionality.

Further the method of the fourth aspect may comprise

co-operating with the multi-access device for establishing a connection from the multi-access device through the access network having been selected as the best access network for the multi-access device, and
receiving the answer to the paging through the established connection.

In an embodiment of the invention said established connection is allowed to be used for communication between the multi-access device and a calling party, which has originally requested paging of the multi-access device.

In an embodiment of the invention the communication network co-operates with the multi-access device for evaluating and selecting the best access network for the multi-access device.

Further one may allow in the method of the fourth aspect registration of at least one preferred access technology to be used for paging given multi-access device.

According to a fifth aspect of the invention there is provided a system comprising a paging center in a communication network comprising at least two access networks according to different access technologies, and a multi-access device, wherein

the paging center comprises a memory, and a processing unit coupled to the memory, the processing unit being configured
to initiate paging of the multi-access device,
to use an access network according to a first default access technology for the paging, and
to wait for to receive an answer to the paging through an access network according to any access technology available in the communication network; and
   wherein the multi-access device comprises a communication unit comprising capabilities for communicating through access networks according to at least two different access technologies, and a processing unit, wherein
the communication unit is configured to receive a paging message at least through an access network according to one of the at least two different access technologies, and
the processing unit is configured to select one of the access networks available for the multi-access device in response to the paging message, and to co-operate with the communication unit to answer to the paging message through the selected access network.

According to a sixth aspect of the invention there is provided a memory medium comprising computer executable program code configured to cause a device to perform the method according to the third aspect of the invention.

According to a seventh aspect of the invention there is provided a memory medium comprising computer executable program code configured to cause a device to perform the method according to the fourth aspect of the invention.

The memory medium of the sixth and seventh aspects may comprise a solid state, optical, magnetic or magneto-optical storage medium. The medium may be such as a flash-ram, memory tape, memory disc, floppy disc, compact disc (CD), digital versatile data disc (DVD).

According to a eighth aspect of the invention there is provided a system a multi-access device comprising:

means for receiving a paging message through an access network according to a first access technology,
means for selecting one of the access networks available for the multi-access device in response to the paging message, and
means for answering to the paging message through the selected access network.

According to a ninth aspect of the invention there is provided a system a paging center comprising:

means for initiating paging of a given multi-access device,
means for using an access network according to a first default access technology for said paging, and
means for waiting for to receive an answer to the paging through an access network according to any access technology available in the communication network, said access network, through which an answer is received, having been selected for the multi-access device in response to said paging.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a block diagram of a system according to an embodiment of the invention;

FIG. 2 shows a flow diagram of a method according to an embodiment of the invention;

FIG. 3 shows a flow diagram of another method according to an embodiment of the invention;

FIG. 4 shows a block diagram of an apparatus suited for implementing various embodiments of the invention; and

FIG. 5 shows a block diagram of a multi-access device suited for implementing various embodiments of the invention.

### DETAILED DESCRIPTION

In the following description, like numbers denote like elements.

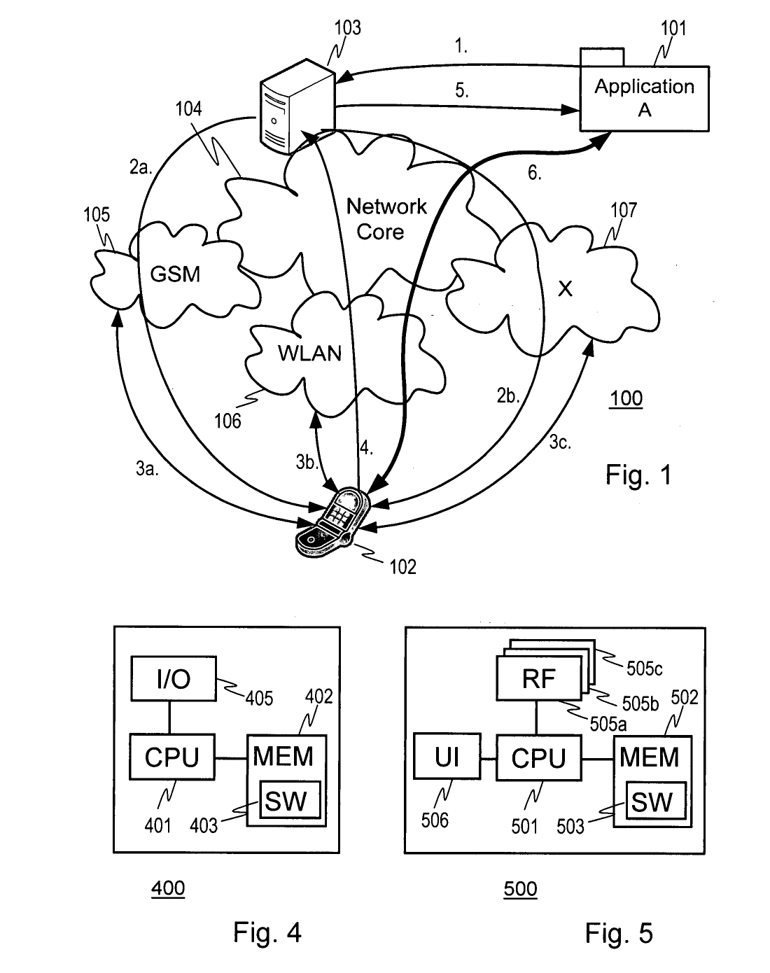

FIG. 1 shows a block diagram of a system 100 according to an embodiment of the invention. The system comprises an application A 101, a communication device 102 and a paging center 103. The paging center resides in a core network 104 of a network operator. In addition to the core network the network of the network operator comprises three access networks, a GSM network 105, a WLAN network 106, and an X network 107 for interfacing with devices of network users. The X network can be any suitable access network. The communication device 102 is a multi-access device that includes capabilities for communicating through all three access networks 105-107. Optionally, the communication device could include capabilities for communicating through one or more additional access network types, i.e. access networks according to different access technologies. Equally, it is not mandatory that the communication device is capable of communicating through all existing access network types of a particular network operator. For the device 102 to be a multi-access device it suffices that at least two access technologies are covered.

Next, operation of an embodiment of the invention in the system of FIG. 1 will be discussed. First application A 101 initiates paging towards the communication device 102. This is depicted with arrow 1. The application A can be a network function, which has detected that someone is trying to contact the communication device 102 and that the communication device 102 no longer exists in the previously known network destination. In this case the application A may be even part of certain paging function of the network. Alternatively the application A may be the application that is trying to contact the communication device 102. Some other alternative may be feasible as well. In the discussed example the application A is the calling application, that is, the application that is trying to contact the communication device 102.

The paging center 103 sends a paging message to the communication device through a preselected or default access network. Arrows 2a and 2b depict paging messages through the GSM network 105 and through the X network 107, respectively. Arrows 2a and 2b are alternatives and both of them are not used at the same time. However, if the communication device cannot be reached through the first preselected access network the paging center may iteratively send the paging message through a plurality of access networks until reaching the communication device succeeds or the available access network types are exhausted. However, preferably only one paging message is first sent and another access network is taken into use if the communication device cannot be reached with the first paging message. Alternatively, multiple access networks may be used in parallel for paging. The alternative that is used in each case may depend on the network operator's and/or user's preferences or some other settings, for example.

Let's say that the communication device 102 receives the paging message for example through the GSM network. Then, the communication device 102 starts to evaluate the available access networks of various access technologies (in this case GSM, WLAN and X) possibly in co-operation with the associated network. Arrows 3a-3c depict this. It must be noted that it is not mandatory to evaluate all available access networks, that is, in some cases only a subset of available access networks may be evaluated. The communication device and/or the associated network select the best/a suitable access network for the desired connection (this may depend on the calling application in addition to the available network resources). The selection does not need to be an autonomous decision either by the communication device or the network. Instead both of them may account for the decision. In addition it is possible that in some cases an actual evaluation of access networks is not performed, if sufficient information is otherwise available for selecting the access network to be used for the desired connection.

The communication device 102 activates the selected best access network and responds to the paging message through the selected access network. In this example the selected access network is the WLAN network and arrow 4 depicts the response. The paging center replies to the application A by informing how to contact the communication device 102 (arrow 5). Optionally, if the application A is located outside the operator network, the paging center (103) may control one or more network entities of the network operator, such as NATs (Network Address Translators) and/or firewalls, to allow the application A to communicate directly with the communication device (102). The application A is then able to open up communication with the communication device 102 (arrow 6). The connection between the communication device and the paging center may be dedicated to paging, whereby a new connection is established between the application A and the communication device. Alternatively the connection, through which the communication device responds to the paging message of the paging center, may be used for communication between the communication device and the application A.

In an embodiment of the invention, a paging center may support more than one operators according to their business/technical agreements. For example, one paging center may be configured to co-operate with a plurality of similar settings as shown in FIG. 1 or different access networks shown in FIG. 1 may be access networks of different operators. That is, the invention is not limited to the use of a single operator network.

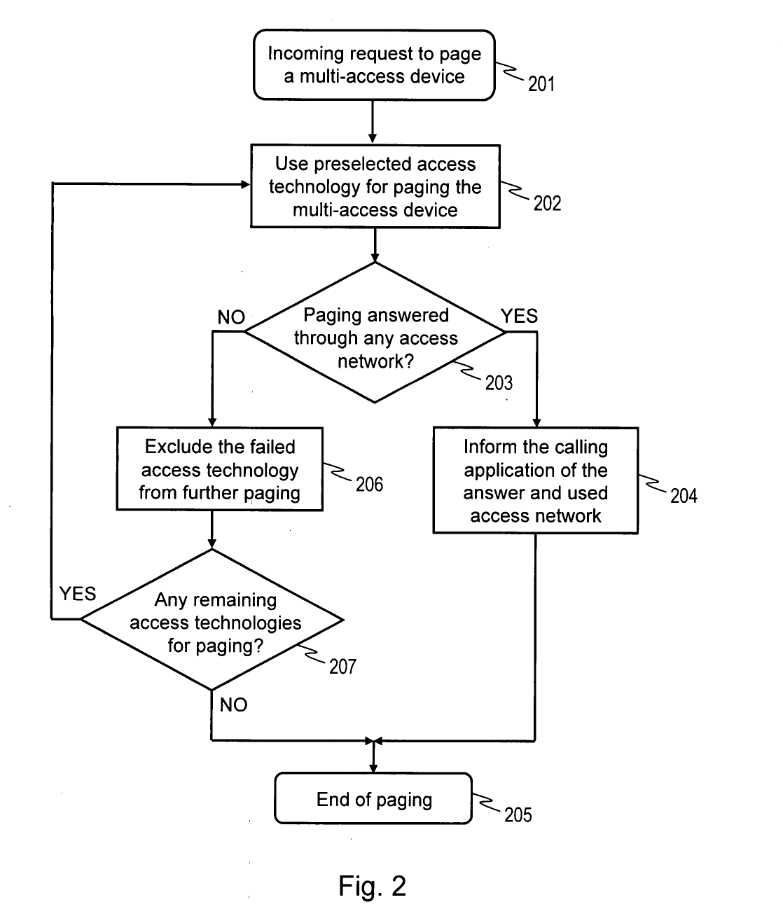

FIG. 2 shows a flow diagram of a method according to an embodiment of the invention. The flow chart illustrates an example of steps that may be performed on the network side. First in phase 201, a request to page a multi-access device comes in for example from a calling application. An access network according to a preselected access technology is used for paging the multi-access device in phase 202. Then, the procedure stops to wait, e.g. for a predetermined time,) for an answer to the paging through any access network in phase 203. If there is an answer, the calling application is informed of the answer and used access network in phase 204. Then the paging is successfully completed and the method proceeds to the end of the paging in phase 205.

If there is no answer to the paging (e.g. during a predetermined period of time), the failed access technology is excluded from further paging (for this particular connection) in phase 206. Then it is checked in phase 207, whether there are any other access technologies available for paging. If there are no remaining access technologies, it is concluded that the paging failed and the method proceeds to the end of the paging in phase 205 (if necessary, the calling party may be informed of failed paging in any suitable manner). If there are other available access technologies, the procedure returns to phase 202 for paging through the available other access technology. Then the procedure iterates itself until an answer is received or the access technologies available for paging are exhausted.

All in all, the paging center does not need to participate in selecting, which access network is used for answering the paging. This selection is typically done outside the paging center, in the multi-access device and/or in the communication network.

It must be noted that all existing access technologies may be available for paging or alternatively it may be defined that only a subset of existing access technologies may be used for paging. That is, there may a list of preselected access technologies to be used for paging. The list may be ordered in the order of preference. The access technologies preferred for paging may be for example well-known or widely utilized access technologies, while some rare access technologies may be excluded from paging use.

In an embodiment of the invention, a multi-access device may change the preselected access technology/ies that are used for paging through a registration procedure. There may be an automated procedure in a multi-access device for using such registration procedure or the option may be manually available for the users of multi-access devices. The preselected access technology/ies may be changed by other authorized persons (such as network operator) as well. Clearly some other embodiments of the invention can be used without such registration procedure. That is, in some cases the network side does not need to know anything about the paging capabilities of the multi-access device. In those cases, the network side may use its best “guess” as the access technology used for paging. Paging may be performed via, for example, a well-known or popular access network.

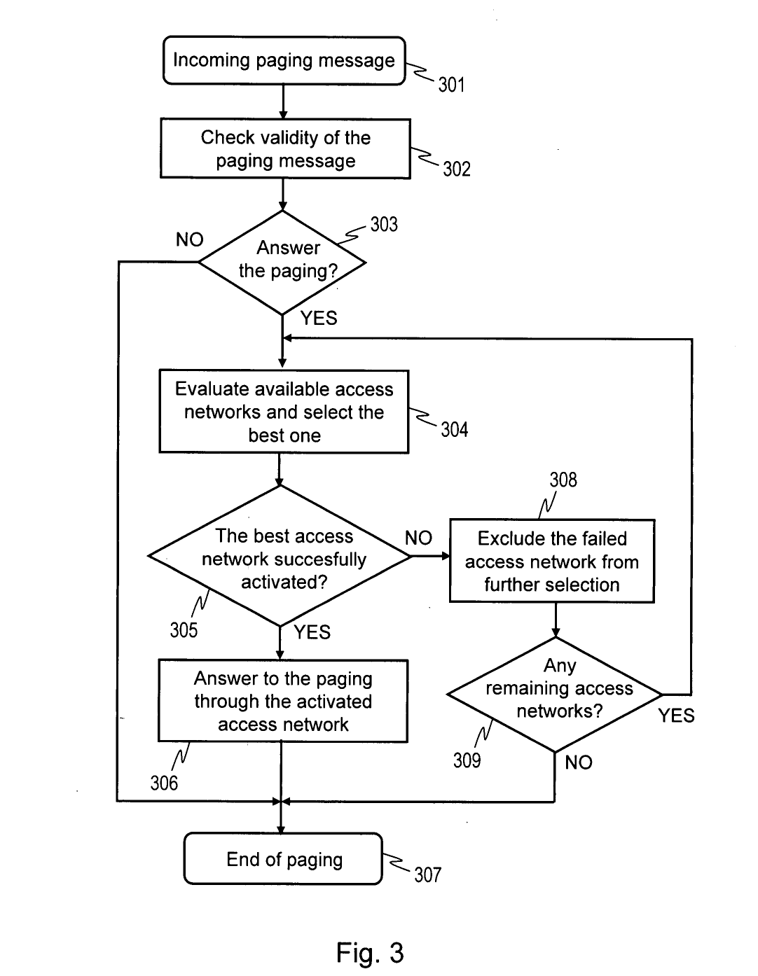

FIG. 3 shows a flow diagram of another method according to an embodiment of the invention. The flow chart illustrates an example of steps that may be performed in a multi-access device. First in phase 301, a paging message comes in from a paging center. Validity of the paging message is checked in phase 302 and in phase 303 it is decided whether to answer the paging or not. If the paging message is not answered the method proceeds to the end of the paging in phase 307, that is, no connection is to be established as a result of this paging/this particular paging failed. It must be noted that optionally the validity check of phase 302 may be left out. It must be noted that the fact that a particular paging fails does not prevent another paging from succeeding. Such another paging may be through the same access network as the failed paging or through some other access network and it may be directed to some other communication device or to the same communication device in a later phase.

If the paging message is to be answered, available access networks (or some of them) are evaluated and the best/a suitable one is selected in phase 304. Like mentioned above, the evaluation and selection of access networks may be performed in co-operation with associated network and various factors may account for the selection process. Then the multi-access device starts to activate the selected best access network in phase 305. If the best access network is successfully activated, the paging is answered through the activated access network in phase 306. The paging is successfully completed and the method proceeds to the end of the paging in phase 307.

If activation of the best access network fails, the failed access network is excluded from further selection (for this particular connection) in phase 308. Then it is checked in phase 309, whether there are any other access networks available. If there are no remaining access networks, it is concluded that the paging failed and the method proceeds to the end of the paging in phase 307. If there are other available access networks, the procedure returns to phase 304 for evaluation and selection of the best one of the remaining access networks. Then the procedure iterates itself until the procedure is successfully completed or available access networks are exhausted.

Optionally the first evaluation and selection round may result in listing available access networks in the order of preference. In that case, the phase 304 in the next round(s) may include only selection of the next preferred access network and no further evaluation of access networks is needed.

The invention may be implemented for example by means of a computer program running on a suitable hardware platform or by means of any other suitable combination of hardware, software, special purpose circuits and/or logic.

FIG. 4 shows a block diagram of an apparatus 400 suited for implementing various embodiments of the invention. The apparatus 400 may be a typical computer, such as, a general-purpose computer or a server, with possibly distributed functions.

The apparatus comprises an input/output (I/O) unit 405, a memory 402 comprising operating instructions, and a processing unit 401 for executing the operating instructions and accordingly controlling other blocks of the apparatus. Optionally the apparatus may comprise a user interface (not shown) for providing output to a user and reading user input, but the user interface may be implemented also by means of a remote connection through the I/O unit 405 or it may be non-existent.

The memory 402 includes a computer program code or software 403 that may comprise instructions for controlling the apparatus to provide some functionality of the invention. The instructions may for example control the apparatus to operate as a paging center according to some embodiments of the invention.

The processor is typically a central processing unit (CPU) or a master control unit MCU. Alternatively, the processor may be a microprocessor, a digital signal processor or an application specific integrated circuit, a field programmable gate array, a microcontroller or a combination of such elements. The I/O (input/output) unit 405 is an interface providing connectivity to other devices. It may be for example a LAN (Local Area Network), Ethernet or WLAN (Wireless LAN) interface or some other communication interface.

FIG. 5 shows a block diagram of a communication device 500 suited for implementing various embodiments of the invention. The communication device is suitable for operating for example as a multi-access device according to embodiments of the invention. The communication device 500 may be a fixed network terminal such as a PSTN or ISDN terminal or a mobile terminal such as a cellular or satellite terminal compatible with a standard or proprietary communications protocol. As an example, the communication device may be a mobile phone, a smart phone or a laptop computer.

The communication device comprises two or more communication units 505a-505c, a memory 502 comprising operating instructions, a user interface 506 for providing output to a user and reading user input, and a processing unit 501 for executing the operating instructions and accordingly controlling other blocks of the communication device.

The memory 502 includes a computer program code or software 503 that may comprise instructions for controlling the communication device to provide some functionality of the invention. The instructions may for example control the apparatus to operate as a multi-access device according to some embodiments of the invention.

The processor is typically a central processing unit (CPU) or a master control unit MCU. Alternatively, the processor may be a microprocessor, a digital signal processor or an application specific integrated circuit, a field programmable gate array, a microcontroller or a combination of such elements. The communication units 505a-505c are interfaces providing connectivity to communication networks. They may be either wireless or fixed line interfaces. Examples of such interfaces are a LAN, Ethernet, WLAN, PSTN, ISDN, GSM, 3G and satellite network interface. The communication units may be separate from each other or integrated to some extent or fully integrated. The user interface 506 typically comprises, for data output, a display and/or a speaker. For data input, the user interface 506 typically comprises one or more of the following: dedicated buttons, soft keys, touch screen, roller, microphone, voice recognition circuitry, and pointing device.

It should be appreciated that in this document, words comprise, include and contain are each used as open-ended expressions with no intended exclusivity.

Particular implementations and embodiments of the invention have been described by way of non-limiting examples. It is clear to a person skilled in the art that the invention is not restricted to details of the embodiments presented above, but that it can be implemented in other embodiments using equivalent means without deviating from the characteristics of the invention. Furthermore, some of the features of the above-disclosed embodiments of this invention could be used without the corresponding use of other features. As such, the foregoing description should be considered as merely illustrative of the principles of the present invention, and not in limitation thereof. Hence, the scope of the invention is only restricted by the appended patent claims.

1. A multi-access device comprising:
a communication unit comprising capabilities for communicating through access networks according to at least two different access technologies, and
a processing unit, wherein
the communication unit is configured to receive a paging message at least through an access network according to one of the at least two different access technologies, and
the processing unit is configured
to select one of the access networks available for the multi-access device in response to the paging message, and
to co-operate with the communication unit to answer to the paging message through the selected access network.

2. A multi-access device according to claim 1, wherein the processing unit is configured to evaluate access networks available for the multi-access device before selecting one of the access networks,

3. A multi-access device according to claim 2, wherein the multi-access device is configured to evaluate the access networks and/or to select the one access network in co-operation with the associated access networks.

4. A multi-access device according to claim 1, wherein the selected access network is the best access network or a suitable access network.

5. A multi-access device according to claim 1, wherein the processing unit in co-operation with the communication unit is configured
to establish a connection between the multi-access device and a paging center through the selected access network, and
to send said answer to the paging message through said established connection.

6. A multi-access device according to claim 3, wherein the processing unit in co-operation with the communication unit is configured to use said established connection between the multi-access device and the paging center for communicating with a calling party, which has originally requested paging of the multi-access device.

7. A multi-access device according to claim 1, wherein the processing unit is configured
to perform a registration procedure with a paging center to register at least one preferred access technology to be used for paging said multi-access device.

8. A paging center for use in a communication network, comprising:
a memory,
a processing unit coupled to the memory, the processing unit being configured
to initiate paging of a given multi-access device,
to use an access network according to a first default access technology for the paging, and
to wait for to receive an answer to the paging through an access network according to any access technology available in the communication network, said access network, through which an answer is received, having been selected for the multi-access device in response to said paging.

9. A paging center according to claim 8, wherein the processing unit is configured to wait for to receive an answer to the paging for a predetermined time, and if an answer is not received during the predetermined time, to use an access network according to another default access technology for the paging.

10. A paging center according to claim 9, wherein the processing unit is further configured to iterate the paging by using access networks according to further default access technologies until an answer is received through some access network or the default access technologies are exhausted.

11. A paging center according to claim 8, wherein the processing unit is further configured to use in parallel two or more access networks according to one or more default access technologies for the paging.

12. A paging center according to claim 8, wherein the processing unit is further configured
to initiate said paging in response to a paging request from an application, and
to inform said application of the access network through which the answer to the paging is received.

13. A paging center according to claim 12, wherein said application is one of the following: a calling application trying to reach said multi-access device, a network function, and a part of a paging functionality.

14. A paging center according to claim 8, wherein the processing unit is further configured
to co-operate with the multi-access device to establish a connection from the multi-access device through the access network having been selected for the multi-access device, and
to receive the answer to the paging through the established connection.

15. A paging center according to claim 14, wherein the processing unit is further configured
to allow said established connection to be used for communication between the multi-access device and a calling party, which has originally requested paging of the multi-access device.

16. A paging center according to claim 8, wherein the processing unit is further configured
to allow registration of at least one preferred access technology to be used for paging a given multi-access device.

17. A method in a multi-access device, the method comprising:
receiving a paging message through an access network according to a first access technology,
selecting one of the access networks available for the multi-access device in response to the paging message, and
answering to the paging message through the selected access network.

18. A method according to claim 17, further comprising
evaluating access networks available for the multi-access device before selecting one of the access networks,

19. A method according to claim 18, wherein said evaluation and/or selection are performed in co-operation with the associated access networks.

20. A method according to claim 17, wherein the selected access network is the best access network or a suitable access network.

21. A method according to claim 17, further comprising
establishing a connection between the multi-access device and a paging center through the selected access network, and
sending said answer to the paging message through said established connection.

22. A method according to claim 21, further comprising using said established connection between the multi-access device and the paging center for communicating with a calling party, which has originally requested paging of the multi-access device.

23. A method according to claim 17, further comprising
performing a registration procedure with a paging center to register at least one preferred access technology to be used for paging said multi-access device.

24. A method in a communication network, the method comprising:
initiating paging of a given multi-access device,
using an access network according to a first default access technology for said paging, and
waiting for to receive an answer to the paging through an access network according to any access technology available in the communication network, said access network, through which an answer is received, having been selected for the multi-access device in response to said paging.

25. A method according to claim 24, further comprising
waiting for to receive an answer to the paging for a predetermined time, and
if an answer is not received during the predetermined time, using an access network according to another default access technology for the paging.

26. A method according to claim 25, further comprising:
iterating the paging by using access networks according to further default access technologies until an answer is received through some access network or the default access technologies are exhausted.

27. A method according to claim 24, further comprising
using in parallel two or more access networks according to one or more default access technologies for the paging.

28. A method according to claim 24, further comprising:
initiating said paging in response to a paging request from an application, and
informing said application of the access network through which the answer to the paging is received.

29. A method according to claim 28, wherein said application is a calling application trying to reach said multi-access device, a network function, or a part of a paging functionality.

30. A method according to claim 24, further comprising:
co-operating with the multi-access device for establishing a connection from the multi-access device through the access network having been selected as the best access network for the multi-access device, and
receiving the answer to the paging through the established connection.

31. A method according to claim 30, further comprising
allowing said established connection to be used for communication between the multi-access device and a calling party, which has originally requested paging of the multi-access device.

32. A method according to claim 24, further comprising:
co-operating with the multi-access device for evaluating and selecting the best access network for the multi-access device.

33. A method according to claim 24, further comprising
allowing registration of at least one preferred access technology to be used for paging given multi-access device.

34. A system comprising a paging center in a communication network comprising at least two access networks according to different access technologies, and a multi-access device, wherein
the paging center comprises a memory, and a processing unit coupled to the memory, the processing unit being configured
to initiate paging of the multi-access device,
to use an access network according to a first default access technology for the paging, and
to wait for to receive an answer to the paging through an access network according to any access technology available in the communication network; and
wherein the multi-access device comprises a communication unit comprising capabilities for communicating through access networks according to at least two different access technologies, and a processing unit, wherein
the communication unit is configured to receive a paging message at least through an access network according to one of the at least two different access technologies, and
the processing unit is configured to select one of the access networks available for the multi-access device in response to the paging message, and to co-operate with the communication unit to answer to the paging message through the selected access network.

35. A memory medium comprising computer executable program code configured to cause a device to perform the method according to claim 17.

36. A memory medium comprising computer executable program code configured to cause a device to perform the method according to claim 24.

37. A multi-access device comprising:
means for receiving a paging message through an access network according to a first access technology,
means for selecting one of the access networks available for the multi-access device in response to the paging message, and
means for answering to the paging message through the selected access network.

38. A paging center comprising:
means for initiating paging of a given multi-access device,
means for using an access network according to a first default access technology for said paging, and
means for waiting for to receive an answer to the paging through an access network according to any access technology available in the communication network, said access network, through which an answer is received, having been selected for the multi-access device in response to said paging.
